(19) United States
(12) Patent Application Publication
(10) Pub. No.: US 2016/0092051 A1
(43) Pub. Date: Mar. 31, 2016

(54) MULTI-PAGE VIEWING WITH CHAPTER AND PAGE SCROLLING

(71) Applicant: Kobo Inc., Toronto (CA)

(72) Inventors: Sneha Patel, Mississauga (CA); Ghazaleh Etezal, Toronto (CA); James Wu, Newmarket (CA)

(21) Appl. No.: 14/503,205

(22) Filed: Sep. 30, 2014

(51) Int. Cl. G06F 3/0483; G06F 3/0485; G06F 3/0484; G06F 3/0488

(52) U.S. Cl. CPC G06F 3/0483; G06F 3/0488; G06F 3/0485; G06F 3/04842

(57) ABSTRACT

A processor selectively operates in one of multiple operational modes, including a page mode to singularly display pages of the e-book in a content region of the display screen, and a multi-page mode to display at least portions of a set of multiple pages of the e-book at one time. When the processor operates in the multi-page mode, the processor responds to (i) receiving a page transition input by determining the current page based on the page transition input, and (ii) receiving a chapter transition input by determining the current page to be a page of a chapter that is determined based on the chapter transition input. In response to determining the current page, the processor displays at least portions of the set of multiple pages, including the current page and portions of one or more of a previous page or next page.

### TECHNICAL FIELD

Examples described herein relate to a computing device that operates to provide multi-page viewing with chapter and page scrolling.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® SurfaceTM, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

E-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system that utilizes an e-reading device that provides multi-page viewing and page or chapter transitioning, according to an embodiment.

FIG. 2 illustrates an example of an e-reading device, for use with one or more embodiments described herein.

FIG. 3 illustrates an e-reading system in accordance with one or more embodiments.

FIG. 4 illustrates a method for operating an e-reading device to include multi-page viewing with page and chapter transitioning, according to an embodiment.

FIG. 5A through FIG. 5D illustrate examples of different viewing modes for viewing pages of an e-book, according to one or more embodiments.

### DETAILED DESCRIPTION

Examples described herein include a computing device that enables multi-page viewing with functionality for providing page and chapter scrolling. Among other benefits, examples such as described enable a user to skim or browse through an e-book, using intuitive input actions that enable the user to have flexibility to readily browse by page and/or chapter selections.

According to an aspect, a computing device includes multiple operational modes, including a multi-page mode that can receive both page transition input and chapter transition input. The use of multiple operational modes enhances an ability of the computing device to function as an e-reading device that can simulate the act of reading physical books. In particular, examples such as described enable reading activities such as skimming.

In one implementation, a computing device includes a memory resource, a touch-sensitive display assembly, and a processor. The processor selectively operates in one of multiple operational modes, including a page mode to singularly display pages of the e-book in a content region of the display screen, and a multi-page mode to display at least portions of a set of multiple pages of the e-book at one time. When the processor operates in the multi-page mode, the processor responds to (i) receiving a page transition input by determining the current page based on the page transition input, and (ii) receiving a chapter transition input by determining the current page to be a page of a chapter that is determined based on the chapter transition input. In response to determining the current page, the processor displays at least portions of the set of multiple pages, including the current page and a portion of a previous page and/or next page. The previous page and/or next page can be determined from the center page.

Still further, a computing device can be operated to switch from a page mode, in which a page of an e-book is displayed by itself on a content region of a display screen, to a multi-page mode, in which a set of multiple pages of the e-book are displayed at one time. When in the multi-page mode, the current page is displayed along with at least a portion of a previous page and/or next page. The computing device can process each of multiple input actions to update the current page. The computing device can detect one or more of the multiple input actions to be a page transition input, and then update the current page based on the page transition input. The computing device can also detect at least one of the multiple input actions to be a chapter designation input, and then update the current page to be a page of a chapter designation that is determined from the chapter designation input.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a multi-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

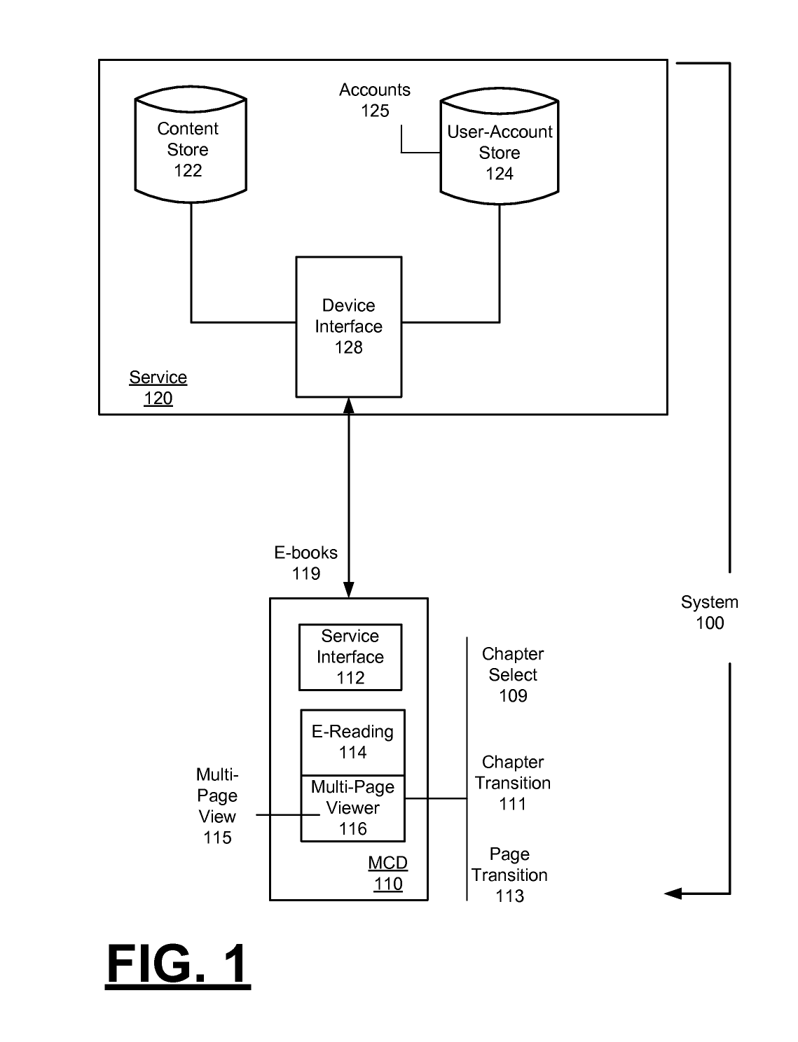

FIG. 1 illustrates a system that utilizes an e-reading device to provide multi-page viewing and enhanced scrolling, according to an embodiment. In an example of FIG. 1, system 100 includes an e-reading device 110 and a network service 120. The network service 120 may include multiple servers and other computing resources that provide various services in connection with one or more applications that are installed on the e-reading device 110. By way of example, in one implementation, the network service 120 can provide e-book services which communicate with corresponding e-reading functionality provided on the e-reading device 110. The e-book services can enable e-books (including electronic magazines and other periodicals) to be downloaded or archived from e-reading device 110. The network service 120 can also provide other forms of content for download or streaming, such as videos or music. In this way, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can correspond to a mobile computing device (e.g., tablet) that runs an e-reading application to link the device to the network service 120 in order to enable e-books provided through the service to be viewed and consumed. Still further, by way of example, the e-reading device 110 can be equipped with hardware and software to optimize certain application activities, such as rendering of electronic content (e.g., e-books, including electronic magazines and other periodicals). For example, the e-reading device 110 can have a tablet like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books 119 and other digital content items that have been purchased or otherwise acquired for the user account 125, but are not stored on the particular computing device.

The e-reading device 110 can include a service interface 112 and an e-reading component 114. The e-reading device 110 can execute the service interface 112 to receive resources and data from the network service 120. The service interface 112 can signal, to the network service 120, an identifier for the user and/or user account. The service interface 112 can interface with the network service 120 to receive resources such as applications and content items (e.g., e-books, music files, etc.) from the network service. Optionally, the e-reading device 110 can communicate with multiple services in order to receive resources. The resources that can be received can be responsive to user-input or action (e.g., purchasing input), or automated (e.g., automatic download of new issue of periodical based on user subscription data).

The e-reading device 110 can execute the e-reading component 114 to enable e-reading activities. In one aspect, the e-reading component 114 can render paginated content from e-books (e.g., electronically formatted literary works). Many e-books, such as literary works which are primarily text-based (e.g., novels) can be paginated on-the-fly by the e-reading component 114, based on, for example, a display size of the device and/or font size settings of the user or device.

According to some embodiments, a multi-page viewer 116 can be provided with the e-reading device 110. The multi-page viewer 116 can, for example, be provided as an integrated feature of the e-reading component 114. Alternatively, the multi-page viewer 116 can be provided as a plugin or separate stand-alone component. In some embodiments, the multi-page viewer 116 can be implemented as a modal feature of the e-reading component 114. The e-reading component 114 can operate in, for example, a default or page mode which renders pages of the e-book on a display in singular fashion, so that the user can view pages of the e-book one page at a time, using the entire display area.

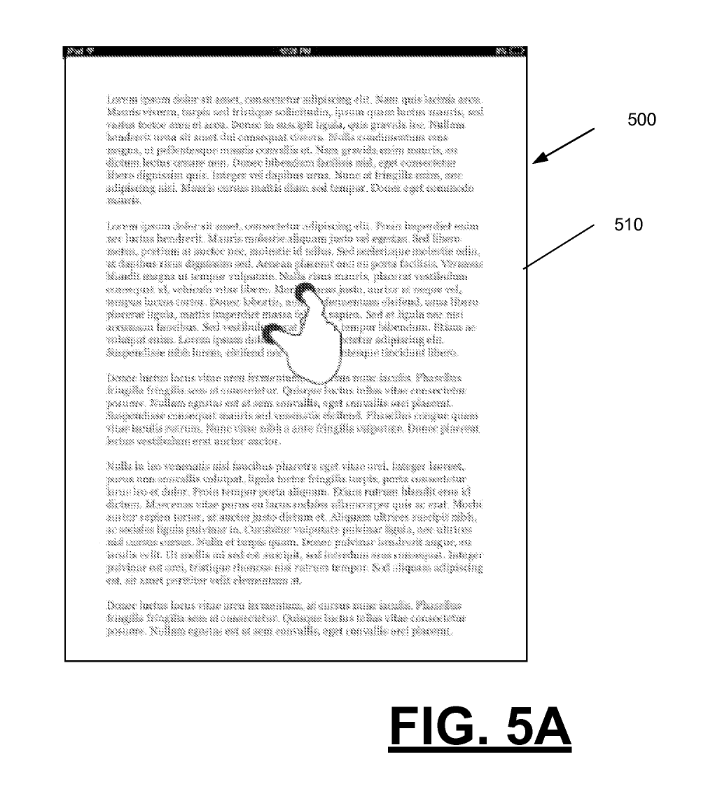

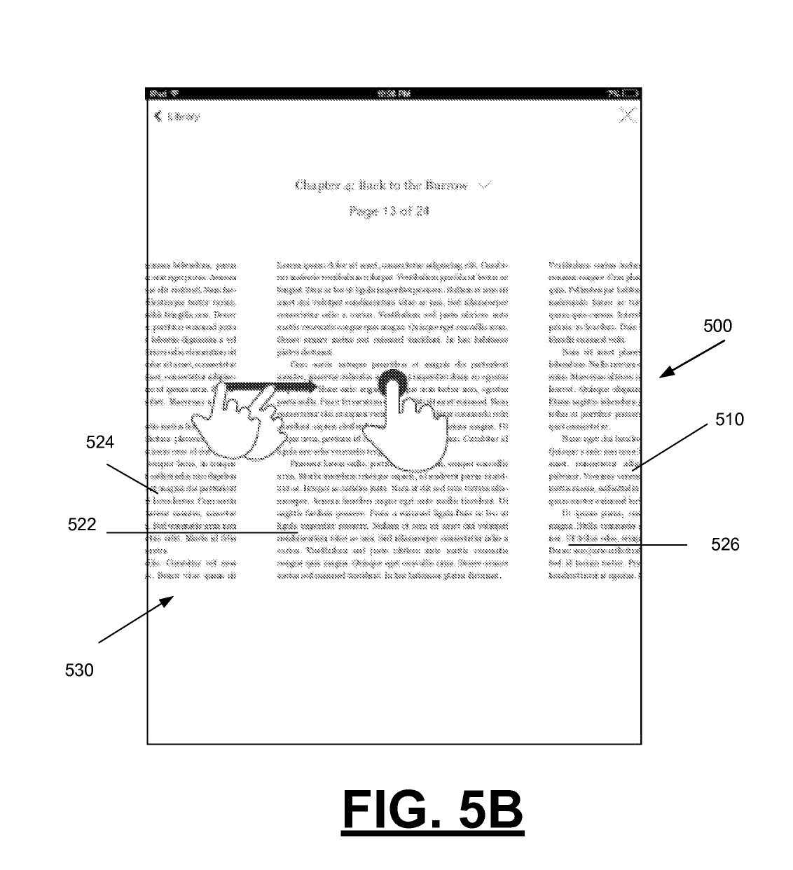

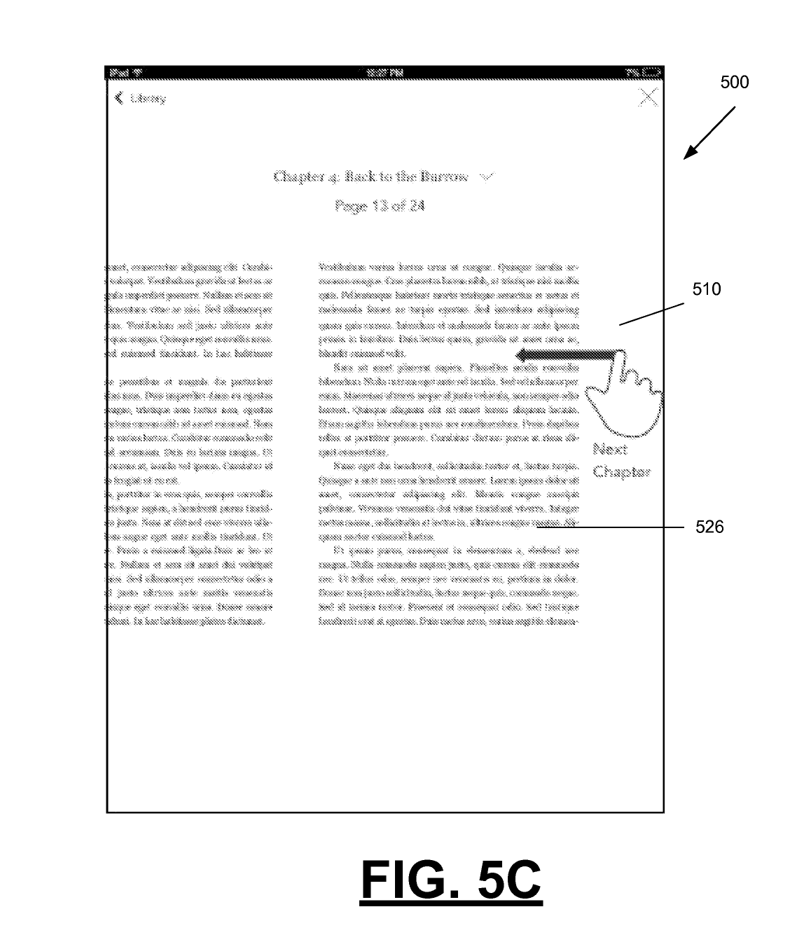

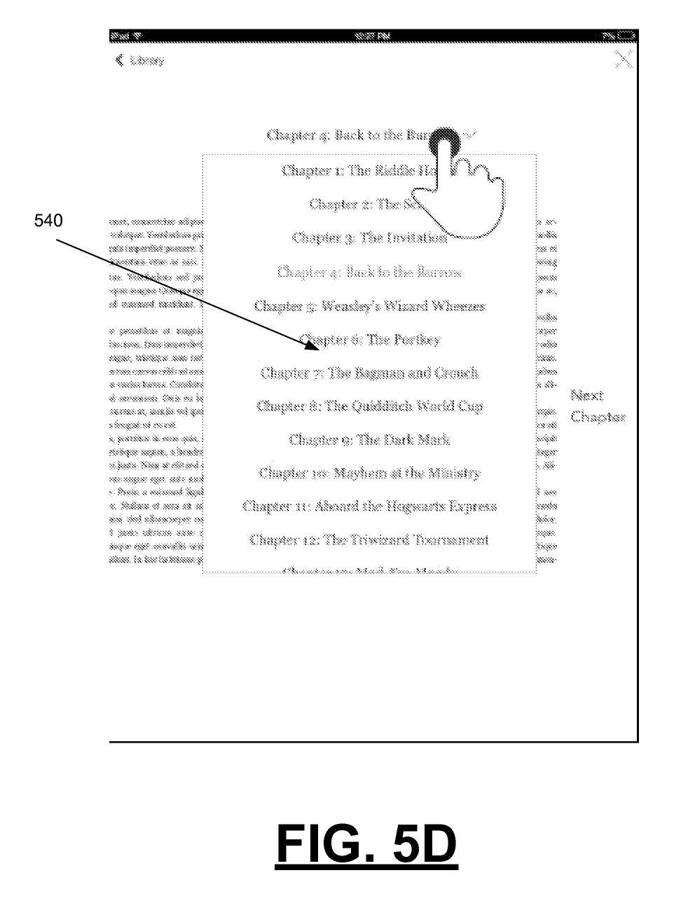

In some embodiments, the use can provide input to trigger the multi-page viewer 116 and switch viewing modes of the e-reading component 114. The e-reading component 114 can recognize, for example, a designated input action (e.g., pinch screen, double tap, etc.) and respond to the user action by switching from the default mode to a multi-page mode. The multi-page viewer 116 can implement or trigger the multi-page mode, during which a multi-page view 115 is generated. In one implementation, the current page is de-magnified (e.g., by 10-30%) when rendered in multi-page view 115, in order to enable the current page to be viewed with one or more adjacent pages in sequence. Additionally, the multi-page viewer 116 can further enable input activity to promote page skimming or quick viewing. In particular, as described with an example of FIG. 5A through FIG. 5D, the multi-page viewer can enable input activity to (i) linearly transition pages of the e-book while maintaining the multi-page view 115, in response to page transition input 113, (ii) enable chapter transition in response to a chapter transition input 111, where current page is transitioned to a page of a next chapter designation, and/or (iii) enable chapter selection 109, where the current page is transitioned to a page of a selected chapter designation of the e-book. The ability to receive input for different kinds of transitions, including page and chapter transitions, enables the multi-page viewer 116 to be used in a manner that enhances or facilitates e-reading activities such as skimming, book flipping or fast reading.

### Hardware Description

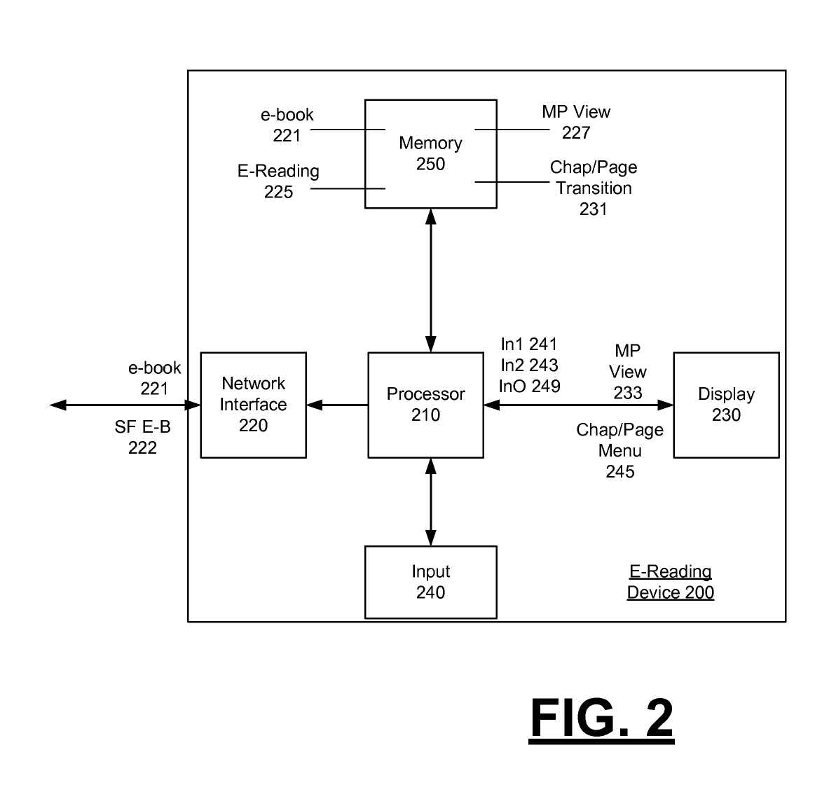

FIG. 2 illustrates an example of an e-reading device for use with one or more embodiments described herein. In an example of FIG. 2, an e-reading device 200 can correspond to, for example, a computing device such as shown described with an example of FIG. 1.

With reference to FIG. 2, e-reading device 200 includes a processor 210, a network interface 220, a display 230, one or more input mechanisms 240, and a memory 250. The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“e-reading instructions 225”) for operating an e-reading application (e.g., see e-reading component 114 of FIG. 1). The memory 250 can also store instructions for generating a multi-page view (“multi-view instructions 227”) for purpose of rendering a portion of an e-book 221 through the display assembly 230 (e.g., see multi-page viewer 116 of FIG. 1). The memory 250 can also store instructions for implementing chapter and page transitions (“chapter/page transition 231”).

The processor 210 can render portions of e-book 221 from memory, and display content from the selected e-book by executing e-reading instructions 225. The processor 210 can respond to input provided through, for example, display 230 to trigger execution of the multi-view instructions 227. When the multi-view instructions 227 are executed to implement a multipage view 233, the processor 210 can respond to specific types of input actions, received through, for example, display 230 or alternatively through the input mechanism 240. In one example, the processor 210 can receive a first type of touch input 241 (e.g., swipe) provided through the display 230, in order to implement a page transition, and a second type of touch input 243 (e.g., long swipe) to implement a chapter transition. The processor 210 can also respond to other input 249 to generate a chapter and title menu 245. The chapter and title menu 245 can enable user selection of a particular chapter designation for the e-book 221.

In run-time, the processor 210 can, for example, retrieve portions of an e-book 221 based on a transition value which can be determined from the touch input. For example, the transition value for the touch input of the first type 241 (page transition) can specify a next page or cluster of pages, and the transition value for touch input of the second type 243 (chapter transition) can specify a first page of a next chapter. Still further, the transition value for a chapter selection input 249 (e.g., made through chapter and title menu 245) can specify a first page of a selected chapter.

### Device System

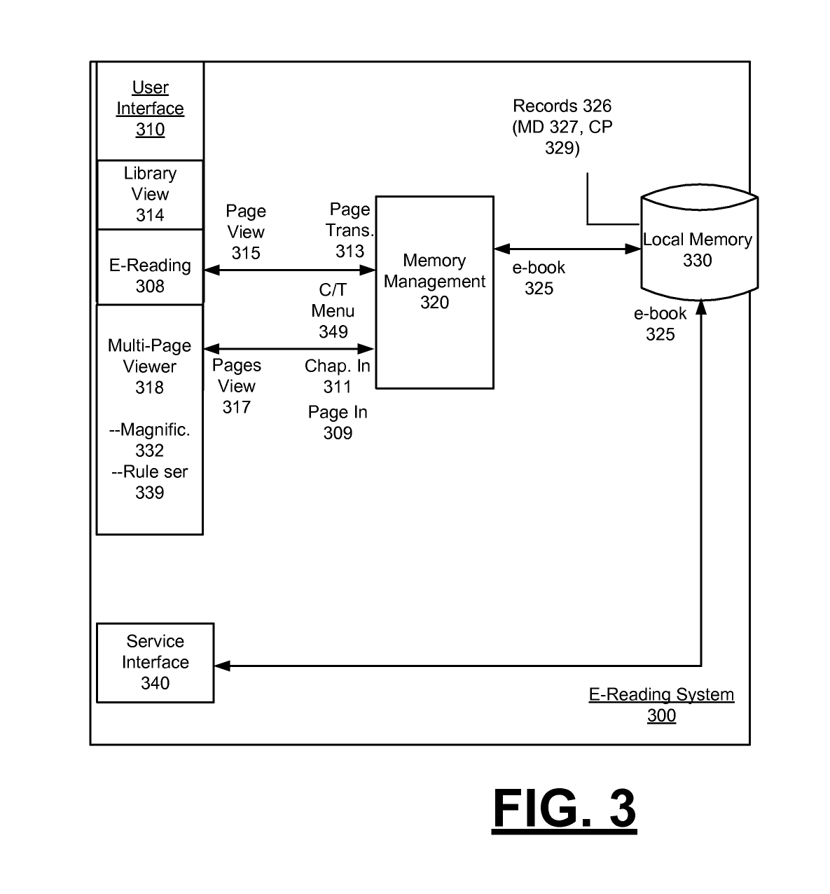

FIG. 3 illustrates an e-reading system in accordance with one or more embodiments. In reference to FIG. 3, a system 300 implements programmatic components for communicating with one or more network service (such as network service 120, shown in FIG. 1), as well as for enabling functionality for viewing and accessing content items (e.g., e-books) utilized by an account associated with the e-reading device 110 (see FIG. 1). In some embodiments, the system 300 can be implemented as an application that runs on an e-reading device, such as shown with examples of FIG. 1 or FIG. 2. In variations, the system 300 can be implemented as part of the operating system for the e-reading device.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reading device 110 (see FIG. 1). For example, the user can download an application onto the device that is operated as the e-reading device 110, in order to obtain functionality such as described with an example of FIG. 3, as well as to communicate with the network service 120. Alternatively, an application can be embedded or otherwise preinstalled with other programmatic elements for providing functionality such as described with system 300.

The service interface 340 includes application logic which enables the e-reading device 110 to use, for example, a wireless Internet connection, to connect to the network service 120 (see FIG. 1). In connecting with the service, the service interface 340 can transmit data that enables the network service 120 to identify the e-reading device 110 on which system 300 is implemented, so that the network service 120 can determine the account that is associated with the particular e-reading device. The service interface 340 can be used to retrieve or receive e-books 325 from the network service 120, which are then stored in the local memory 330. For example, in identifying the e-reading device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels), as well as pagination provided by periodicals (e.g., magazines, comic books, journals, etc.). Many e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device. The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reading device 110 to automatically receive their previously purchased e-book. As another example, network service 120 can be configured to push e-books to the e-reading device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reading device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user. According to some embodiments, the local memory 330 stores each e-book as a record 326 that includes metadata 327 and content 329 (e.g., page content).

The memory management module 320 can include a combination of memory resources, including cache resources that are coupled or integrated for use with the user interface 310 and/or e-reading component 308. The memory management module 320 can store portions of the content 329 for individual e-books for purpose of rendering e-books via the user interface 310. Additionally, the memory management module 320 can retrieve metadata 327 to render metadata content (e.g., representations of e-books or lists of e-books) with the user interface 310. By way of example, the memory management module 320 can include a cache resource (or combination of cache resources) that is utilized by the user-interface 310 to render e-book content in the format of a page, or combination of pages. The formatting of the portion of the e-book can be performed, for example, on-the-fly or in response to user input.

In an example of FIG. 3, the user interface 310 of e-book system 300 includes an e-reading component 308 and a library view component 314. A multi-page viewer 318 can be implemented as a modal feature of the e-reading component 308. The e-reading component 308 can be implemented in a page mode which displays the pages of an e-book in singular fashion, so that a page occupies an entirety of a content region of a display surface. In this mode, the e-reading component 308 includes functionality to (i) render page views 315 from a particular e-book, and (ii) detect page transition events 313. The page views 315 can include the content portion 329 of the e-book being read (e.g., opened or rendered). For example, the e-reading component 308 can display a page view 315 from an e-book corresponding to a novel or periodical, and the page view may include text and/or image content. The page event 313 can correspond to, for example, a page turn, a chapter turn, or a clustered page turn. The page transition events 313 can be received as touch input through the e-reading component 308. For example, a simple page turn can be signaled through touch input 309 as a tap, provided in a direction that the user desires for the page transition.

The library view 314 can display objects and metadata that represent individual e-books and content items of the user library. In one implementation, the library view 314 can display metadata content based on the metadata portion 327 of individual e-books that are in the user library. The e-books that are in the user library can correspond to e-books stored with local memory 330, as well as archived e-books that are provided remotely (e.g., provided on network service 120).

More specifically, in some implementations, the memory management module 320 can be triggered into archiving e-books. In archiving an e-book, the content portion 329 of the e-book can be removed from the local memory 330, while the metadata portion 327 of the record 326 remains stored in the local memory 330. The trigger for archiving e-books can be based on the user input, or generated programmatically in response to events such as memory management processes (e.g., process to archive e-books that have been read; process to detect when free memory is below threshold, etc.). The library view component 314 can display the representation of the archived e-books using the metadata content 327.

The multi-page viewer 318 can be triggered with a designated user input action, so that the e-reading component 308 operates in a multi-page mode that displays pages of the e-book in a multi-page format. An example of a multi-page format is shown with FIG. 5A through FIG. 5D. When in the multi-page format, the e-reading component 308 processes input actions that include page transition input 309 and chapter transition input 311. The e-reading component 308 can determine page or chapter transition values 309, 311 in retrieving page views 317. In rendering multi-page view 317, one example provides that the page views 317 retrieved from the memory management module 320 include an update to one or more of current page, a previous page, and/or a next page, in accordance with a predetermined page sequence of the e-book. In this way, when the updated current page is determined, the updated previous and/or next page can also be displayed.

Among other functions, the multi-page viewer 318 implements formatting to reduce magnification of the current page (as would be compared to the page transition or default mode), so that the current page can be displayed alongside portions of other pages. The multi-page viewer 318 can, for example, include a magnification setting 332 to reduce the magnification automatically when the multi-page mode is triggered.

The multi-page viewer 318 can also makes viewable portions of the previous page on one portion of the display screen (e.g., to the left of the center page), and/or of the next page on another portion of the display screen. By way of example, the multi-page viewer 318 can define a programmatic window from which the multiple pages are to be rendered in their entirety, and the dimension of the programmatic window can exceed the dimension of a defined content region of display screen on which pages are displayed. This can create the effect that only a portion of the previous and/or next page is shown alongside the current page. In some examples, when page transition is in effect, a graphic feature can be implemented to show movement of the pages in a given direction (e.g., left-to-right, or right-to-left). For example, when three pages or displayed in the multi-view, a net result of a page transition can be that the current page is moved over (e.g., to previous page when transitioning forward), one of the next or previous page is made current and displayed in full (e.g., next page is made current page) while the other is removed from the view (e.g., previous page is removed when page transition is forward), and a previously un-displayed page is partially rendered in a new position (e.g., as a new next page).

For a chapter transition, the selected chapter designation can be determined from the chapter transition input 311. In one implementation, the chapter transition input 311 is a linear value that can be correlated to a next chapter (or another chapter) based on a value of the input.

As an alternative or variation, the chapter transition input 311 is a selection of a particular chapter. For example, in some variations, the e-reading component 308 can generate a chapter and title menu 349. A user can enter chapter selection input to transition to viewing pages from a specific chapter.

Based on the chapter transition input 311, a new chapter is identified. In one implementation, the current page is selected as the first page of the chapter, and at least one of (i) the previous page is selected as the last page of the preceding chapter, and (ii) the next page is selected as being the next page of the selected chapter. As an alternative implementation, the current page can correspond to a randomly selected page within the selected chapter, or determined from a previously viewed page within the selected chapter. Still further, as another alternative, the current page can be determined from other triggers, such as the location of the current page in a current chapter, so that the chapter transition is to a proportionate location in the selected chapter.

In some variation, the movement of page transitions when multi-page view is provided can reflect velocity. In particular, a velocity value can be determined from one or more characteristics of a corresponding input action. For example, a page transition can be implemented in response to a user swipe on the display screen, and the velocity and/or dimension of the swipe can be correlated to page transition velocity.

In some variations, the multi-page viewer 318 includes a rule set 339 for implementing a physics engine. The rule set 339 can be implemented for the multi-page view to simulate movement of the pages based on detected characteristics of the input action, such as velocity. Still further, the rule set can combine characteristics of repeated input to generate simulation of momentum or velocity, particularly in context of multi-page input. Thus, when the user ceases input, or is in between input actions (e.g., short swipes), the pages displayed in the multi-view may continue to move.

As the multi-page viewer 318 enables skimming, the page and chapter transition values can be received repeatedly or continuously over a short duration of time (e.g., seconds or a minute). The e-reading component 308 can receive and generate multi-page views repeatedly, in a manner that corresponds to transition values determined through interaction with the multi-page viewer 318.

While an example of FIG. 3 describes chapter transition and selections occurring in the context of multi-page view, in variations, functionality for enabling chapter transition and selection can be provided in alternative viewing modes. For example, the page or default mode can enable the user to transition chapters using a same designated input action (e.g., swipe), as well as to select chapters using a menu feature.

### Methodology

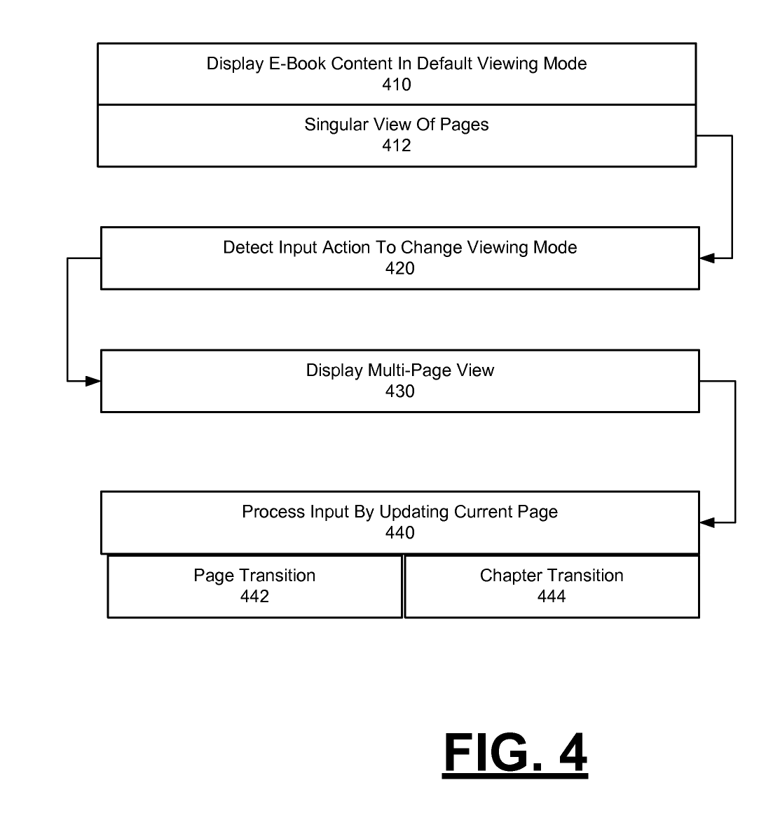

FIG. 4 illustrates a method for operating an e-reading device to include multi-page viewing with page and chapter transitioning, according to an embodiment. An example such as described by FIG. 4 can be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, an e-reading device 110 displays e-book content in a default viewing mode (410). The default viewing mode can correspond to, for example, a page mode in which pages of an e-book are singularly displayed at full magnification (given text size settings) on an available content region of the display screen. In a default mode, a user can view one page of an e-book at a time at maximum magnification. Some settings, such as font selection, can affect the amount of text that is presented on a page. For example, cache resources of memory management module 320 can retain text for portion of an e-book that is being read, and the e-reading component 308 can define pages for rendering in the default mode based on font and other settings.

The viewing mode of the e-reading device can be changed to a multi-page view in response to a designated event (420). For example, a user can provide a designated input action (e.g., pinch action when making contact with touch-sensitive screen) to trigger the e-reading device 110 to switch to the multi-page view.

A multi-page view can be generated using the current page upon the device being placed in the multi-page mode (430). In the multipage mode, a current page is displayed in full, while one or more adjacent pages to the current page are at least partially displayed. Still further, the multiple pages of the multipage view can be aligned linearly, such as in a horizontal direction, to simulate a physical book. The number of pages that can be displayed at one time, as well as the portion of the individual pages which are displayed in the multi-page view, can be based on design and/or setting preferences. Some examples described herein include a current page, with portions of each of a previous page and a next page. In variations, a greater number of pages can be displayed, such as (i) the current page, previous page and next page, each being displayed in full, and (ii) one or more adjacent pages to either the previous and/or next page being displayed in part. Still further, in other variations, the multipage view can include two pages, such as a previous page and a current page, or a current page and a next page. As an addition or alternative, the motion simulated with the transition of pages can vary the number of pages that are present in the multi-page view at any one time. For example, when the pages of the multi-view are centered, a current page may be centrally positioned and displayed in its entirety, while a previous and next page are partially displayed on opposing sides of the current page. But as the pages move, more of the incoming page (e.g., next page when transitioning forward) is displayed and less of the previous page remains in the multi-view until a point when the current page and next page are displayed in the respective entirety. As the transition continues, another page is newly received in multi-page view, and the once current page is moved partially and then completely outside of the boundary of the multi-page view.

The e-reading device 110 can process input to update the current page. The update can be based on any of the pages displayed in the multipage view. As described with other examples, multiple types of input can be received to transition through the e-book and to update the current page. The multiple types of input can include page transition input (442) and chapter transition input (444).

In one implementation, a page transition input can result in a page transition in either a forward or backward direction. For example, in the forward direction, the e-reading device 110 can implement the page transition to (i) update the current page to be the prior next page, (ii) update the previous page to be the prior current page, and (iii) update the next page as a new arrival. The page transition input can be implemented in varying speeds, and optionally enable cluster transitions, such that the difference between the current page displayed to the user at adjacent time interval varies by more than one page number in the sequence (e.g., ten pages are skipped). The e-reading device 110 can recognize different inputs to signify single page transitions (e.g., single tap) versus cluster page transitions (e.g., tap and hold, rapid swipe or tapping, etc.).

With chapter transition input, the e-reading device 110 can process a first type of chapter input to skip to a next chapter, based on pre-determined chapter designations of the e-book. For example, the e-reading component 308 can display multiple pages from a given chapter (e.g., Chapter 2) of a given e-book before receiving a chapter transition input. One type of chapter transition input can specify either a next or prior chapter, depending on the directional characteristic of the input. For example, the user can enter an input with a directional characteristic (e.g., swipe, tap or double tap in a given direction, or swipe, tap or double tap in a right or left side of the display screen etc.), and the e-reading component 308 displays the next or prior chapter designation based on the detected directional characteristic.

As an alternative to chapter transition input, the e-reading device 110 can process chapter selection input. For example, the e-reading component 308 can generate the chapter and title menu 349 to enable user selection of a specific chapter.

When the e-book is transitioned by chapter, the multi-view can display multiple pages centered about a particular location of the selected chapter. The particular location that is initially displayed as a result of the chapter transition or selection can correspond to, for example, a first page, a page the user previously viewed from the chapter, or a page in the selected chapter that is proportionately located as compared to a current page and chapter.

### EXAMPLES

FIG. 5A through FIG. 5D illustrate examples of different viewing modes for viewing pages of an e-book, according to one or more embodiments. In an example of FIG. 5A through FIG. 5D, an e-reading device 500 includes a display screen 510, having a content region that is within a border of the display screen.

FIG. 5A illustrates the e-reading device 500 operating in a page mode, where the content region displays a current page. As shown by FIG. 5A, to switch viewing modes, the user can provide a designated input action. The designated input action can be a touch type input, provided by the user on the display screen. In an example of FIG. 5A, the designated touch input can correspond to a pinch action. In variations, other types of input, such as a tap, double tap or other input action can be provided.

FIG. 5B illustrates an example of a multi-page view 530. In the muli-page mode, a current page 522 is de-magnified so that it appears as a tile within the content region. Additionally, a portion of a previous page 524 and a portion of a next page 526 are shown adjacent to the current page 522. The user can enter page transition input by, for example, swiping the screen. Directional input can cause the pages to transition forward or backward in response to the input. Each input action can be processed independently or collectively with prior input actions. For example, a series of three swipes can collectively result in a greater page transition. Additionally, the movement of the pages can be visually implemented to carry velocity and momentum, so as to continue moving moments after contact is stopped.

In FIG. 5C, the user can specify a chapter transition input. The chapter transition input can be an extension of a page transition input. For example, the e-reading device 500 can process a short swipe as a page transition input, and a long swipe as a chapter transition input.

FIG. 5C also illustrates that the allocation of page content can shift and be dynamic. For example, the (prior) next page 526 can be transitioned to the current page 524, and two pages can be displayed in greater portions as the transition is taking place.

FIG. 5D illustrates a chapter and title menu feature 540 for selecting chapters from the e-book. The user can tap, for example, an entry of the menu to select a chapter designation of the e-book.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a memory resource to store a set of instructions and an e-book;
a display assembly including a display screen, the display assembly being touch-sensitive;
one or more processors that access the memory resource to:
selectively operate in one of multiple operational modes, including a page mode to singularly display pages of the e-book in a content region of the display screen, and a multi-page mode to display at least portions of a set of multiple pages of the e-book at one time;
when operating in multi-page mode, the one or more processors operate to:
respond to receiving a page transition input by determining the current page based on the page transition input;
respond to receiving a chapter transition input by determining the current page to be a page of a chapter that is determined based on the chapter transition input; and
in response to determining the current page, display at least portions of the set of multiple pages, including the current page and one or more of (i) at least a portion of a previous page in a first side position to the current page, or (iii) at least a portion of a next page in a second side position to the current page, the previous page or next page being determined from the current page.

2. The computing device of claim 1, wherein the one or more processors display the current page with a greater magnification when operating in the page mode as compared to the multi-page mode.

3. The computing device of claim 1, wherein the one or more processors operate in the multi-page mode to display only a portion of the previous page or of the next page.

4. The computing device of claim 1, wherein the one or more processors detect a first type of touch input display assembly corresponding to the page transition input, and a second type of touch input on the display assembly corresponding to the chapter transition input.

5. The computing device of claim 4, wherein the second type of touch input is an extended form of the first type of touch input.

6. The computing device of claim 5, wherein the first type of touch input is a swipe, and the second type of touch input is a long swipe.

7. The computing device of claim 1, wherein the one or more processors operate in the page mode by default, and switch into the multi-page mode in response to receiving a designated mode switch input.

8. The computing device of claim 7, wherein the designated mode switch input corresponds includes a touch input selected from a pinch, a tap on the display screen or a double tap.

9. The computing device of claim 1, wherein the one or more processors operate to provide a menu feature that can be viewed when operating in either the page mode or multi-page mode, the menu feature identifying chapter designations of the e-book and enabling the user to provide a specific chapter designation selection to transition the current page to a page of the selected chapter designation.

10. A method for operating a computing device, the method being implemented by one or more processors and comprising:
selectively switching from a page mode, in which a page of an e-book is displayed by itself on a content region of a display screen, to a multi-page mode, in which a set of multiple pages of the e-book are displayed at one time;
wherein in the multi-page mode, the current page is displayed along with one or more of (ii) at least a portion of a previous page is displayed in a first side position to the current page, a (iii) at least a portion of a next page is displayed in a second side position to the current page, the previous page and next page being determined from the current page;
processing each of multiple input actions to update the current page, including performing each of:
detecting one or more of the multiple input actions to be a page transition input and updating the current page based on the page transition input, and
detecting at least one of the multiple input actions to be a chapter designation input and updating the current page to be a page of a chapter designation that is determined from the chapter designation input.

11. The method of claim 10, wherein switching from the page mode to the multi-page mode includes reducing magnification of the current page.

12. The method of claim 10, wherein switching from the page mode to the multi-page mode includes display only a portion of each of the previous page and the next page.

13. The method of claim 10, wherein processing each of multiple input actions includes detecting a first type of touch input corresponding to the page transition input, and a second type of touch input corresponding to the chapter transition input.

14. The method of claim 13, wherein the second type of touch input is an extended form of the first type of touch input.

15. The method of claim 14, wherein the first type of touch input is a swipe, and the second type of touch input is a long swipe.

16. The method of claim 10, further comprising operating in the page mode by default, and selectively switching includes switching into the multi-page mode in response to receiving a designated mode switch input.

17. The method of claim 16, wherein the designated mode switch input corresponds includes a touch input selected from a pinch, a tap on the display screen or a double tap on a display screen.

18. The method of claim 10, further comprising operating to provide a menu feature that can be opened when operating in either the page mode or multi-page mode, the menu feature identifying chapter designations of the e-book and enabling the user to provide a specific chapter designation selection to transition the current page to a page of the selected chapter designation.

19. A non-transitory computer-readable medium that stores instructions that, when executed by one or more processors of a computing device, cause the computing device to perform operations that include:
selectively switching from a page mode, in which a page of an e-book is displayed by itself on a content region of a display screen, to a multi-page mode, in which a set of multiple pages of the e-book are displayed at one time;
wherein in the multi-page mode, the current page is displayed along with one or more of (ii) at least a portion of a previous page is displayed in a first side position to the current page, and (iii) at least a portion of a next page is displayed in a second side position to the current page, the previous page and next page being determined from the current page;
processing each of multiple input actions to update the current page, including performing each of:
detecting one or more of the multiple input actions to be a page transition input and updating the current page based on the page transition input, and
detecting at least one of the multiple input actions to be a chapter designation input and updating the current page to be a page of a chapter designation that is determined from the chapter designation input.

20. The non-transitory computer-readable medium of claim 19, wherein switching from the page mode to the multi-page mode includes reducing magnification of the current page.
